(19) United States
(12) Patent Application Publication
(10) Pub. No.: US 2008/0155784 A1
(43) Pub. Date: Jul. 3, 2008

(54) HINGE ASSEMBLY AND FOLDABLE ELECTRONIC DEVICE WITH SAME

(75) Inventors: SHENG-CHENG HSU, Tu-Cheng (TW); PU LUO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen)CO.,LTD., Shenzhen City (CN); HON HAI PRECISION INDUSTRY CO., LTD., Tu-Cheng (TW)

(21) Appl. No.: 11/873,417

(22) Filed: Oct. 17, 2007

(30) Foreign Application Priority Data
Oct. 24, 2006 (CN) 200610201020.0

(51) Int. Cl. E05F 1/12

(52) U.S. Cl. 16/303

(57) ABSTRACT

An exemplary hinge assembly includes a shaft, a cam, a pin, a follower, a shift member, a socket, a first spring, and a second spring. A pinhole is defined in the shaft. The cam, the follower, and the shift member are rotatably sleeved on the shaft. The cam has a cam surface and a spiral slot. The pin is disposed in the pinhole and the spiral slot. The follower has an anti-rotating portion and a cam surface for engaging with the cam surface of the cam. The shift member has a controlling portion for slidably engaging with the anti-rotating portion. The first and the second spring are sleeved on the shaft. An end of the first spring resists the follower and another end of the first spring resists the shift member. An end of the second spring resists the follower and another end of the second spring resisting the socket.

### BACKGROUND OF THE INVENTION

1. Field of the Invention

The present invention generally relates to hinge assemblies, and particularly to a hinge assembly typically employed in a foldable electronic device.

2. Discussion of the Related Art

Generally, a majority of components of a foldable electronic device is contained in a first housing, also known as a main body. A second housing, also known as a cover, normally contains fewer components than the main body. Some foldable electronic devices have all the electronic components in the main body, with the cover containing no components. Various types of hinge assemblies are used to join the main body and the cover of a foldable electronic device to allow the cover to flip open from and fold over the main body. Foldable electronic device manufacturers constantly explore ways to reduce the volume, size, and/or weight of the portable foldable electronic devices. Thus, it is desirable that the hinge assembly coupling the main body and the cover is also modularized and miniaturized. A modularized hinge assembly has moving parts such as a cam, a follower, a shaft, and a spring held together in a unified structure. Either the cam or the follower directly contacts the spring. The spring applies a force such that the cam and the follower are always in contact each other.

In use, if a user wants to open the foldable electronic device, the user has to push the cover. In most cases, the user holds the foldable electronic device with one hand and opens the cover with the other hand. In other cases, the user holds the foldable electronic device and pries open the cover with fingers of the same hand. This method of opening the cover is not convenient and the foldable electronic device may be easily dropped from the hand. Thus, the foldable electronic device is not convenient for users who want to open the cover with one hand.

Therefore, a new hinge assembly is desired in order to overcome the above-described shortcoming that some foldable electronic devices are not easy to open with one hand.

### SUMMARY

An exemplary hinge assembly includes a shaft, a cam, a pin, a follower, a shift member, a first resilient element, a socket, and a second resilient element. A pinhole is defined in the shaft. The cam has a cam surface and a spiral slot, and is rotatably sleeved on the shaft. The pin is disposed in the pinhole of the shaft and the spiral slot of the cam. The follower has a cam surface and an anti-rotating portion. The follower is rotatably sleeved on the shaft, with the cam surface of the follower engaging with the cam surface of the cam. The shift member has a controlling portion, and is rotatably sleeved on the shaft. The controlling portion of the shift member is slidably engaged with the anti-rotating portion of the follower so that the shift member is slidable and non-rotatable relative to the follower. The first resilient element is sleeved on the shaft with a first end of the first resilient element resisting the follower and an opposite second end of the first resilient element resisting the shift member. The socket is secured on the shaft. The shift member is able to lock into and unlock from the socket. The second resilient element is sleeved on the shaft. A first end of the second resilient element resists the follower to drive the cam surface of the follower to engage with the cam surface of the cam and an opposite second end of the second resilient element resisting the socket.

Other novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present hinge assembly and foldable electronic device. Moreover, in the drawings, like reference numerals designate corresponding parts throughout the several views.

FIG. 1 is an isometric view of a mobile phone incorporating a hinge assembly (shown in phantom) in accordance with a preferred embodiment of the present invention.

FIG. 2 is a status of the assembled, isometric view of the hinge assembly of FIG. 1 when the cover of the phone of FIG. 1 is closed.

FIG. 3 is an exploded, isometric view of the hinge assembly of FIG. 2.

FIG. 4 is similar to FIG. 3, but showing the hinge assembly viewed from another aspect.

FIG. 5 is an isometric, cross-sectional view of the hinge assembly of FIG. 2.

FIG. 6 is a status of the assembled, isometric view of the hinge assembly of FIG. 1 when opening the cover of the phone of FIG. 1.

FIG. 7 is a status of the assembled, isometric view of the hinge assembly of FIG. 1 when the cover of the phone of FIG. 1 is open.

FIG. 8 is a status of the assembled, isometric view of the hinge assembly of FIG. 1 when closing the cover of the phone of FIG. 1.

### DETAILED DESCRIPTION OF THE EMBODIMENTS

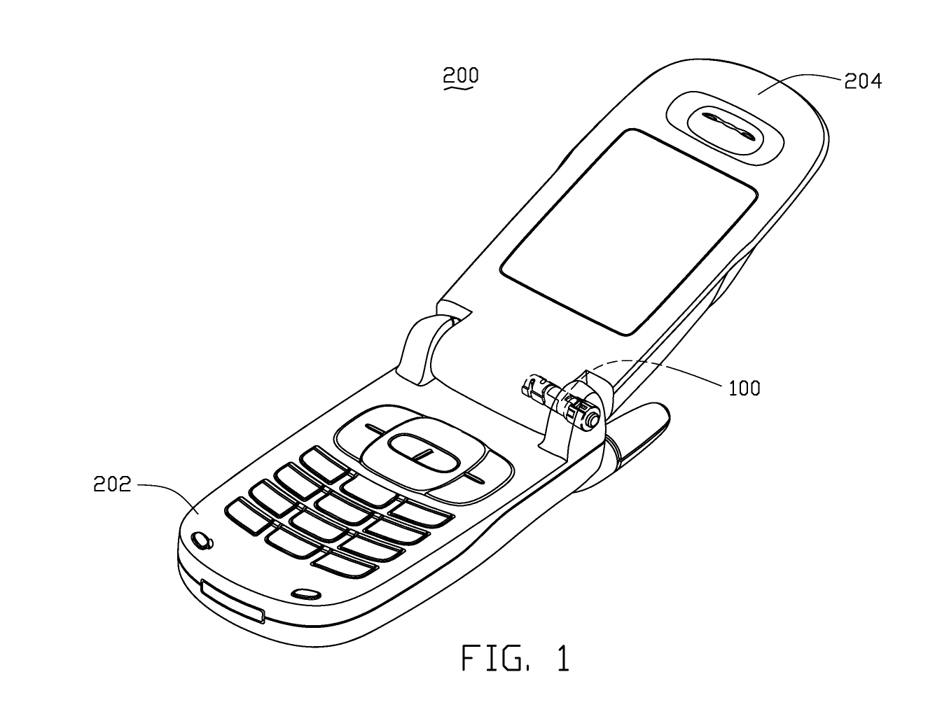

The present application relates to a hinge assembly used in foldable electronic devices that include two components rotatably attached to each other such as mobile phones and personal digital assistants. For convenience and brevity, the hinge assembly as used in a mobile phone is described and illustrated. Referring to the drawings in detail, FIG. 1 shows a mobile phone 200 incorporating a hinge assembly 100 (shown in phantom). The mobile phone 200 includes a main body 202 and a cover 204. The main body 202 and the cover 204 are pivotably connected to each other via the hinge assembly 100.

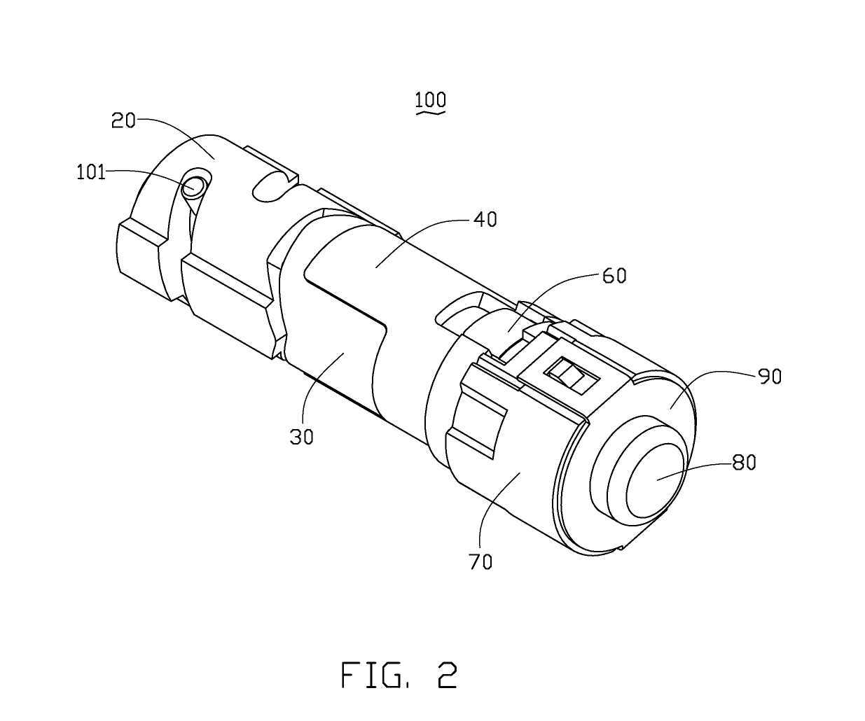

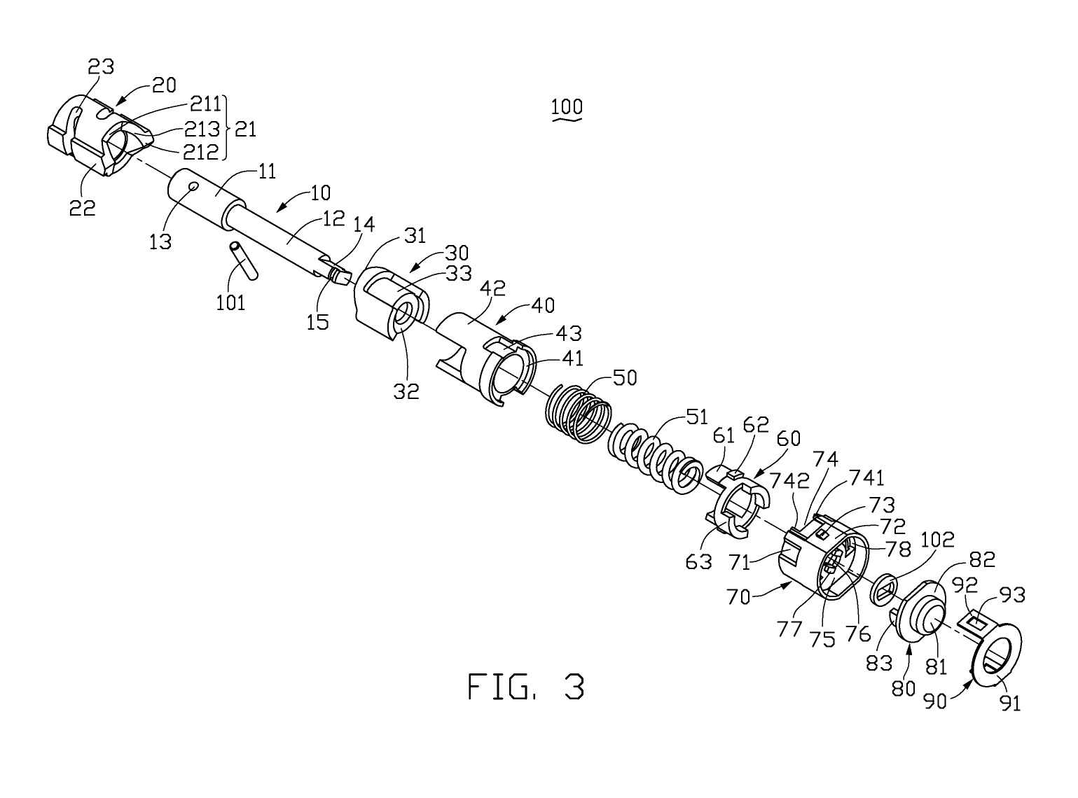

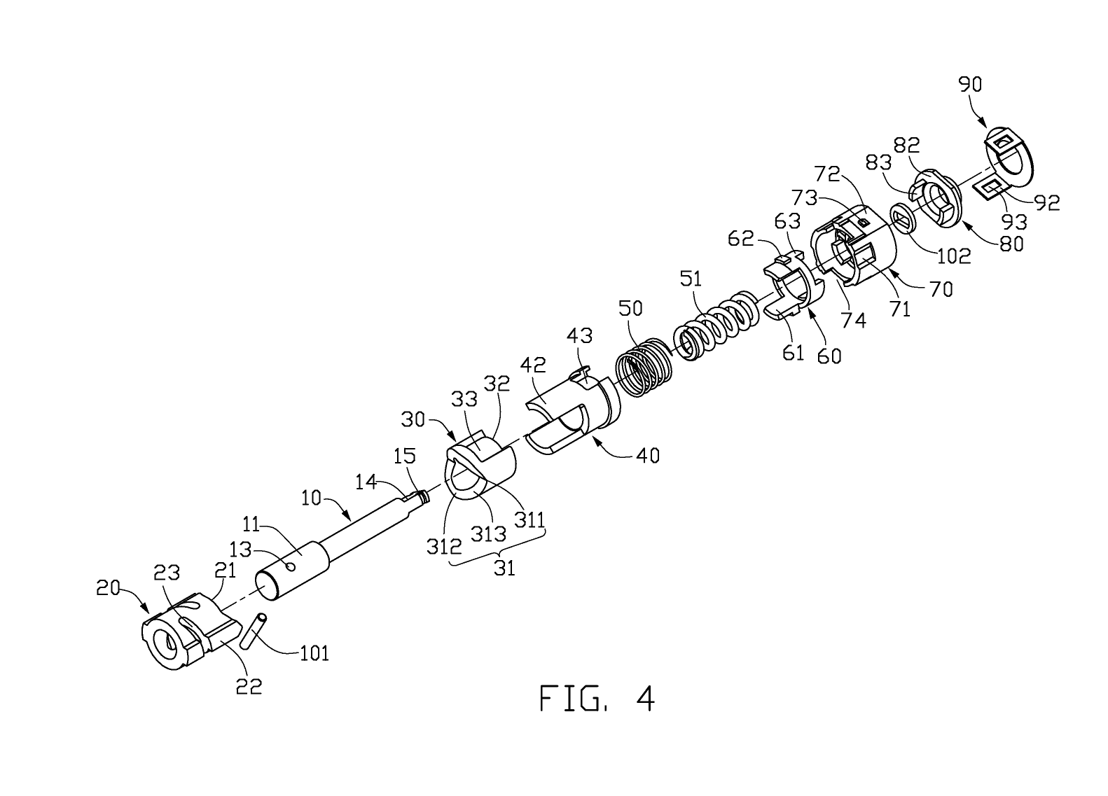

Referring to FIGS. 2 through 4, the hinge assembly 100 includes a shaft 10, a cam 20, a follower 30, a sleeve 40, a first resilient element 50, a second resilient element 51, a shift member 60, a socket 70, a button 80, a fixing member 90, a pin 101, and a clip 102.

The shaft 10 is substantially cylindrical. The shaft 10 includes a shaft head 11 and a shaft body 12 extending from an end (not labeled) of the shaft head 11. The shaft head 11 and the shaft body 12 are also substantially cylindrical and a diameter of the shaft head 11 is greater than that of the shaft body 12. Furthermore, a head cylindrical axis of the shaft head 11 and a body cylindrical axis of the shaft body 12 lie on a same line. A pinhole 13 is defined in the shaft head 11. The pinhole 13 is through hole that perpendicularly intersects with the head cylindrical axis. A top end (not labeled) of the shaft body 12 connects with a bottom end of the shaft head 11. A bottom end (not labeled) of the shaft body 12 opposite to the top end defines a deformed shaft portion 14. The deformed shaft portion 14 defines two symmetrical recesses (not labeled) on opposite sides of the cylindrical surface to form a stub 15.

The cam 20 is substantially a hollow cylinder, and is rotatably sleeved on the shaft head 11. The cam 20 forms a cam surface 21 at a bottom end (not labeled). The cam surface 21 includes two troughs 211, two peaks 212, and two sloped surfaces 213 connecting the troughs 211 and the peaks 212 correspondingly. Two spiral slots 23 are defined in opposite sides of a cylindrical sidewall of the cam 20. Two protrusions 22 are formed on opposite sides of the cylindrical sidewall. The protrusions 22 are configured for engaging with the cover 204 of the mobile phone 200 such that the cam 20 is non-rotatable relative to the cover 204.

The follower 30 is substantially a hollow cylinder, and is rotatably sleeved on the shaft 10. A top end of the follower 30 defines an open end (not labeled), and a bottom end of the follower 30 opposite to the top end defines a partially open end (not labeled). Two symmetrical sliding grooves 33 are defined in opposite sides of a cylindrical surface of the follower 30. The follower 30 has a cam surface 31 on the open end. The cam surface 31 of the follower 30 is configured for engaging with the cam surface 21 of the cam 20, and includes two troughs 311, two peaks 312, and two sloped surfaces 313 connecting the troughs 311 and the peaks 312 correspondingly. The partially open end of the follower 30 has a flat surface 32.

The sleeve 40 is substantially a hollow cylinder, and is rotatably sleeved on the shaft body 12. A top end of the sleeve 40 defines an open end (not labeled), and a bottom end of the sleeve 40 opposite to the top end defines a partially open end 41. Two symmetrical guiding grooves 43 are defined in opposite sides of a cylindrical surface of the sleeve 40. The sleeve 40 defines two cutouts (not labeled) from the open end in opposite sides of the cylindrical sidewall of the sleeve 40, forming two sliding arms 42. The cutouts extend from the open end to a middle portion of the sleeve. The sliding arms 42 are configured for engaging with the sliding grooves 33 of the follower 30 such that the sleeve 40 is slidable along a horizontal direction in the sliding grooves 33 of the follower 30.

The first resilient element 50 is preferably a metallic helical spring. The first resilient element 50 is sleeved on the shaft body 12 and partially accommodated in the shift member 60. A top end (not labeled) of the first resilient element 50 resists the partially open end 41 of the sleeve 40 and a bottom end (not labeled) of the first resilient element 50 opposite to the top end resists the shift member 60. It can be understood that the first resilient element 50 is not restricted to metallic material and can be other elastic members, such as a hollow cylindrical rubber tube.

The second resilient element 51 is preferably a metallic helical spring. A diameter of the second resilient element 51 is smaller that that of the first resilient element 50. The second resilient element 51 passes through the first resilient element 50 and is sleeved on the shaft body 12 and accommodated in the sleeve 40 and the shift member 60. A top end (not labeled) of the second resilient element 51 resists the flat surface 32 of the follower 30 and a bottom end (not labeled) of the second resilient element 51 opposite to the top end resists the socket 70. It can be understood that the first resilient element 50 is not restricted to metallic material and can be other elastic members, such as a hollow cylindrical rubber tube.

The shift member 60 is substantially a hollow cylinder, is sleeved on the shaft body 12, and is partially accommodated in the socket 70. The shift member 60 defines two cutouts in opposite sides of the cylindrical sidewall of shift member 60 from a top end (not labeled), forming two guiding arms 61. The guiding arms 61 are configured for engaging with the guiding grooves 43 of the sleeve 40 such that the shift member 60 is non-rotatable relative to the sleeve 40 and slidable in the guiding grooves 43 of the sleeve 40. Each of the guiding arms 61 defines a rectangular tab 62 on opposite sides of the cylindrical surface A bottom end (not labeled) of the shift member 60 opposite to the top end defines two resisting portions 63. The resisting portions 63 resist the bottom end of the first resilient element 50.

The socket 70 is substantially a hollow cylinder, and is sleeved on the deformed shaft portion 14 of the shaft 10. A securing portion 71 and two latching portions 72 are formed on opposite sides of the cylindrical surface of the socket 70. The securing portion 71 has a groove. The securing portion 71 is configured for engaging with the main body 202 of the mobile phone 200 such that the socket 70 is non-rotatable relative to the main body 202. Each of the latching portions 72 forms a hook 73. A top end of the socket 70 defines two symmetrical pits 74. The pits 74 of the socket 70 are configured for engaging with the tabs 62 of the shift member 60 such that when the tabs 62 are received in the pits 74, the shift member 60 is non-rotatably locked into the socket 70. An inside wall of the socket 70 forms a separating plate 75 at a middle portion of thereof. The separating plate 75 defines a deformed hole 76 at a center thereof. The deformed hole 76 is a through hole. The deformed hole 76 is configured for engaging with the deformed shaft portion 14 of the shaft 10 such that the socket 70 is non-rotatable relative to the shaft 10. A shape and a size of the deformed hole 76 correspond to that of the deformed shaft portion 14 of the shaft 10. The separating plate 75 also defines a rib 77 adjacent to the deformed hole 76. The rib 77 is configured for enhancing strength of the separating plate 75. The separating plate 75 further defines two symmetrical through holes 78 adjacent to the inside wall of the socket 70.

The button 80 includes a pressing portion 81, a flange 82 connecting with the pressing portion 81, and two symmetrical shift drivers 83 extending from an end opposite to the pressing portion 81 of the flange 82. Each of the shift drivers 83 passes through one the through hole 78 of the socket 70 and resists one corresponding resisting portions 63 of the shift member 60.

The fixing member 90 has an annular securing sheet 91 and two hook receivers 92 perpendicularly extending from the securing sheet 91. The pressing portion 81 of the button 80 passes through the securing sheet 91 such that the securing sheet 91 resists the flange 82 of the button 80. Each of the hook receivers 92 defines a rectangular latching hole 93. The latching hole 93 is configured for receiving the hook 73 of the socket 70 such that the hook receivers 92 of the fixing member 90 are secured in the latching portions 72 of the socket 70, thereby the button 80 is prevented from popping out of the socket 70.

The pin 101 acts as a positioning member, and is cylindrical. A shape and a size of the pin 101 are corresponding to those of the pinhole 13 of the shaft 10 and the spiral slots 23 of the cam 20. The pin 101 is configured for engaging with the pinhole 13 of the shaft 10 and the spiral slots 23 of the cam 20 such that the cam 20 is rotatable relative to the shaft 10 when the cam 20 is moving along the shaft 10.

The clip 102 is disposed at the stub 15 of the shaft 10 and resists the rib 77 of the socket 70, thereby the socket 70 is prevented from sliding along the shaft 10. More over, the deformed hole 76 is configured for engaging with the deformed shaft portion 14 such that the socket 70 is non-rotatable relative to the shaft 10. Thus, the socket 70 remains stationary relative to the shaft 10.

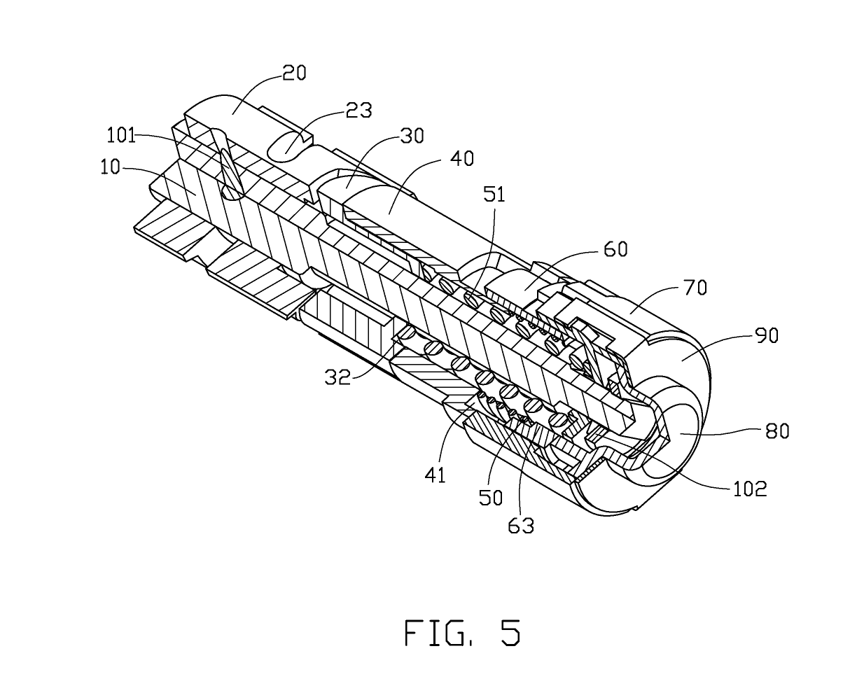

Referring also to FIG. 5, in assembly, the cam 20 is sleeved onto shaft head 11 of the shaft 10 in a way such that the cam surface 21 of the cam 20 faces a same direction as the extending direction of shaft body 12 of the shaft 10. Then, the spiral slots 23 of the cam 20 are aligned with the pinhole 13 of the shaft head 11 and the pin 101 is inserted one of the spiral slot 23, the pinhole 13, and another of the spiral slot 23 in that order. Thus, the cam 20 is slidable and rotatable relative to the shaft 10.

The follower 30 is sleeved onto the shaft body 12 of the shaft 10 in a manner such that the cam surface 31 of the follower 30 faces the cam surface 21 of the cam 20.

The sleeve 40 is sleeved onto the shaft body 12 of the shaft 10 in a manner such that each of the sliding arms 42 of the sleeve 40 is received in a corresponding one of the sliding grooves 33 of the follower 30.

The first resilient element 50 is sleeved onto the shaft body 12 of the shaft 10 and passes through the sleeve 40 in a manner such that the top end of the first resilient element 50 resists the partially open end 41 of the sleeve 40.

The second resilient element 51 is sleeved onto the shaft body 12 of the shaft 10 and passes through the sleeve 40 and the first resilient element 50 in a manner such that the top end of the second resilient element 51 resists the flat surface 32 of the follower 30.

The shift member 60 is sleeved onto shaft body 12 of the shaft 10 and the second resilient element 51 in a manner such that each of the guiding arms 61 of the shift member 60 is received in a corresponding one of the guiding grooves 43 of the sleeve 40 and the bottom end of the first resilient element 50 resists the resisting portions 63 of the shift member 60.

The deformed shaft portion 14 of the shaft 10 is received in the deformed hole 76 of the socket 70 in a manner such that the bottom end of the second resilient element 51 resists the separating plate 75 of the socket 70 and the tab 62 of the shift member 60 is received in the pits 74 of the socket 70, with the tab 62 of the shift member 60 abutting against a first inside wall 741 of the pit 74 of the socket 70.

The clip 102 is engaged with the stub 15 of the shaft 10 and resists the rib 77 of the socket 70, whereby the socket 70 is prevented from sliding along the shaft 10. The follower 30, the sleeve 40, the shift member 60, and the socket 70 are non-rotatable relative to each other. Then each of the shift driver 83 of the button 80 passes through a corresponding one of the through holes 78 of the socket 70 and resists a corresponding one of the resisting portions 63 of the shift member 60. The pressing portion 81 of the button 80 passes through the securing sheet 91 of the fixing member 90 such that the securing sheet 91 resists the flange 82 of the button 80 and the hook 73 of the socket 70 is received in the latching hole 93 of the fixing member 90. Assembly of the hinge assembly 100 is thus completed.

In use, the securing portion 71 of the socket 70 is engaged with the main body 202 of the mobile phone 200, and the protrusions 22 of the cam 20 is engaged with the cover 204 of the mobile phone 200. In alternative embodiments, the protrusions 22 may be engaged with the main body 202 of the mobile phone 200 such that the cam 20 is non-rotatable relative to the main body 202.

When the mobile phone 200 is in a normal state, the cover 204 is closed and abuts the main body 202. In this state, each of the peaks 312 of the follower 30 is received in a corresponding one of the troughs 211 of the cam 20. The second resilient element 51 exerts a force on the follower 30 and the follower 30 exerts a force on the cam 20. Because the pin 101 is located in the spiral slots 23 of the cam 20 and the pinhole 13 of the shaft 10, the cam 20 will slide when rotating relative to the shaft 10. Similarly, the cam 20 will rotate when sliding relative to the shaft 10. Thus the cam 20 is under urging to move along the shaft 10 with a direction of the force that the second resilient element 51 exerts on the follower 30. Therefore, the cam 20 is under urging to rotate relative to the shaft 10. In addition, the second resilient element 51 exerts a force on the follower 30, and the cam 20 abuts against the follower 30 directly, thus the follower 30 is under urging to rotate relative to the shaft 10 together with the cam 20. The follower 30, the sleeve 40 and the shift member 60 are slidably and non-rotatably engaged with each other such that any one of the follower 30, the sleeve 40 and the shift member 60 is non-rotatable relative to other two, thus the sleeve 40 and the shift member 60 are all under urging to rotate relative to the shaft 10. However, the shift member 60 is locked into the socket 70 such that the shift member 60, sleeve 40, the follower 30 and the cam 20 are all non-rotatable relative to the shaft 10. Thus the cam 20 remains stationary relative to the shaft 10.

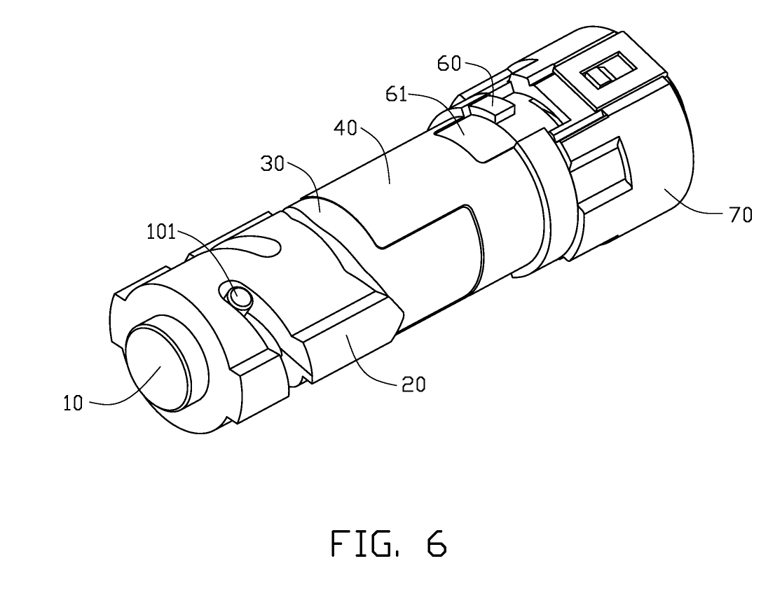

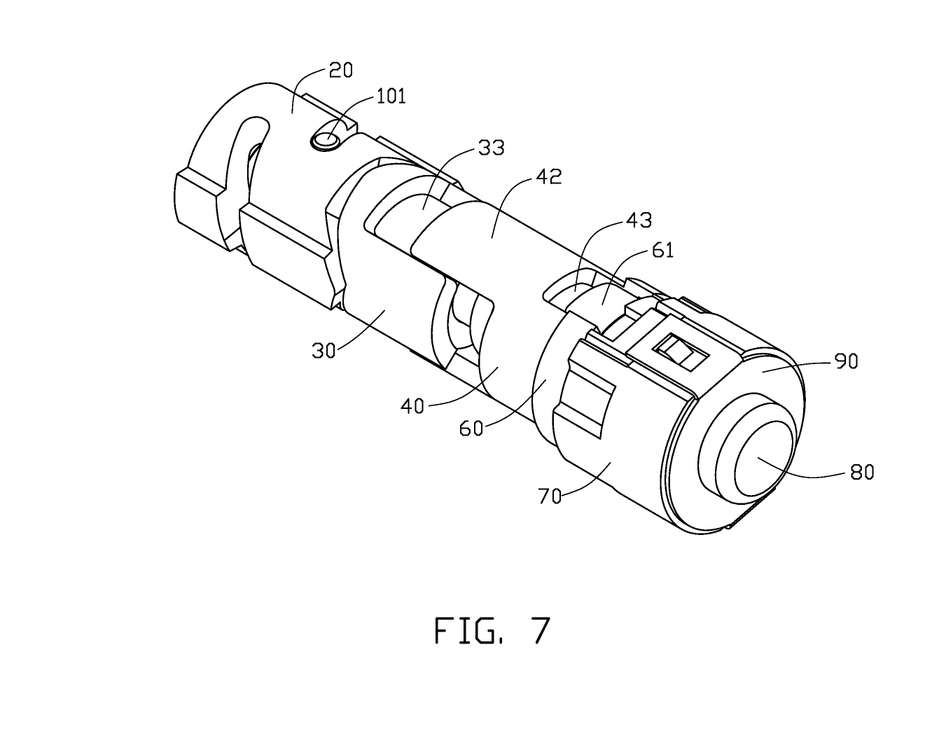

Referring to FIGS. 6 and 7, to open the cover 204 of the mobile phone 200, the pressing portion 81 of the button 80 is pressed. The shift driver 83 of the button 80 pushes the resisting portions 63 in order to drive the shift member 60 to move along the guiding grooves 43 of the sleeve 40 due to the guiding arms 61 are received in the guiding grooves 43. When the shift member 60 is pushed, the shift member 60 would push the first resilient element 50. The first resilient element 50 is compressed and accumulates energy. The first resilient element 50 pushes the sleeve 40 and the shift member 60 to slide in an opposite direction at the same time. In this moment, the sleeve 40 would push the follower 30 and the cam 20 is pushed by the follower 30. The shift member 60 also has a trend to get back to its original position in a direction along an axis of the shaft body 12.

Meanwhile, the tabs 62 of the shift member 60 disengages from the pits 74 of the socket 70, thus the shift member 60 is unlocked from the socket 70. That is the shift member 60, the sleeve 40, and the follower 30 are all rotatable. The second resilient element 51 exerts a force on the follower 30 and pushes the follower 30. When the follower 30 is pushed, the follower 30 would push the cam 20. Thus the cam 20 moves along the shaft 10 with a direction of the force that the second resilient element 51 exerts on the follower 30.

The cam 20 will rotate when sliding relative to the shaft 10. The second resilient element 51 pushes the follower 30, and then the follower 30 resists and follows the cam 20. The first resilient element 50 pushes the sleeve 40, and then the sleeve 40 resists and follows the follower 30. As a result, the sleeve 40 and the follower 30 both move along and rotate relative to the shaft 10 together with the cam 20. The cam 20 drives the follower 30, the sleeve 40 and the shift member 60 to rotate relative to shaft 10 together. When the cam 20 has rotated a certain degree, the cover 204 is flipped open automatically. That is, an user only need to press the pressing portion 81 of the button 80, the cover 204 is flipped open automatically.

When the cover 204 is flipped open, the shift member 60 rotate the same degrees. Since the shift member 60 also has a trend to get back to its original position in a direction along an axis of the shaft body 12 and there is no other force exerting on the shift member 60, the resisting portions 63 of the shift member 60 fall into the pits 74 of the socket 70 with the tab 62 of the shift member 60 resisting another inside wall 742 of the pits 74 of the socket 70. As a result, the shift member 60 is locked into the socket 70 again.

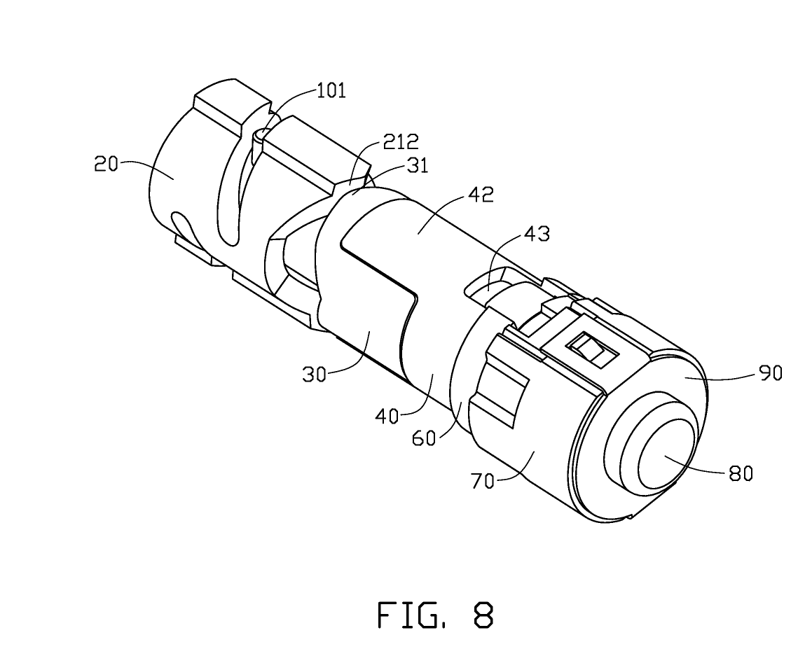

Referring to FIG. 8, When closing the cover 204, an external force is manually applied on the cover 204 by a user. Thus, the cover 204 drives the cam 20 to rotate relative to the shaft 10 and move along the shaft 10 toward the follower 30.

When the shift member 60 is locked into the socket 70, the follower 30, the sleeve 40, and the shift member 60 are non-rotatable relative to the shaft 10. The peaks 212 of the cam 20 relatively move along the sloped surfaces 313 of the follower 30 from the troughs 311 to the peaks 312 of the follower 30 when the cam 20 rotates. Meanwhile, the follower 30 slides along the sliding arms 42 of the sleeve 40 and compresses the second resilient element 51. Then the follower 30 drives the sleeve 40 to move along the shaft 10. The first resilient element 50 and the second resilient element 51 are all compressed and accumulate elastic potential energy.

When the cam 20 rotates to a certain degree and each of the peaks 212 of the cam 20 passes over a corresponding one of the peaks 312 of the follower 30, each of the peaks 312 of the follower 30 slides into a corresponding one of the troughs 211 of the cam 20 due to the force of the second resilient element 51. Then the cover 204 is fully closed down onto the main body 202, and the mobile phone 200 is back to its normal state.

It can be understood that, the sleeve 40 may be omitted. In such case, the shift member 60 directly abuts against the follower 30. The guiding members 61 of the shift member 60 may be other configuration, such as guiding grooves. The follower 30 may be replaced with other anti-rotating portion, such as guiding members. The shift member 60 may form a controlling portion configured for engaging with the anti-rotating portion of the follower 30 such that the shift member 60 is non-rotatable and slidable relative to the follower 30. More over, the first resilient element 50 may directly abut against the follower 30 and the shift member 60.

It can be understood that, the sliding arms 42 of the sleeve 40 and the sliding grooves 33 of the follower 30 may be other suitable configurations if they could drive the sleeve 40 to slide relative to the follower 30 with no rotating relative to the sleeve 40. In alternative embodiments, the guiding arms 61 of the shift member 60 and the guiding grooves 43 of the sleeve 40 may be other suitable configurations if they could drive the shift member 60 to only slide with no rotating relative to the sleeve 40. More over, the tab 62 of the shift member 60 and the pits 74 of the socket 70 may be other suitable configurations if they could drive the shift member 60 to lock into and unlock from the socket 70. The diameter of the shaft head 11 of the shaft 10 may be equal to that of the shaft body 12 of the shaft 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge assembly comprising:
a shaft, wherein a pinhole is defined in the shaft;
a cam having a cam surface and a spiral slot, the cam rotatably sleeved on the shaft;
a pin disposed in the pinhole of the shaft and the spiral slot of the cam so that the cam being slidable and rotatable relative to the shaft;
a follower having a cam surface and an anti-rotating portion, the follower rotatably sleeved on the shaft, and the cam surface of the follower engaging with the cam surface of the cam;
a shift member having a controlling portion, the shift member being rotatably sleeved on the shaft, the controlling portion of the shift member slidable engaged with the anti-rotating portion of the follower so that the shift member being slidable and non-rotatable relative to the follower;
a first resilient element sleeved on the shaft, with a first end of the first resilient element resisting the follower and an opposite second end of the first resilient element resisting the shift member;
a socket secured on the shaft, the shift member locked into or unlocked from the socket; and
a second resilient element sleeved on the shaft, with a first end of the second resilient element resisting the follower to drive the cam surface of the follower to engage with the cam surface of the cam and an opposite second end of the second resilient element resisting the socket.

2. The hinge assembly as claimed in claim 1, wherein the hinge assembly further includes a sleeve, the sleeve is sleeved on the shaft and between the follower and the shift member, the follower and the shift member are slidably engaged with the sleeve.

3. The hinge assembly as claimed in claim 2, wherein the follower has a sliding groove, the sleeve has a sliding arm, the sliding arm of the sleeve is slidably engaged in the sliding groove.

4. The hinge assembly as claimed in claim 2, wherein the sleeve has a guiding groove, the shift member has a guiding arm, the guiding arm is slidably engaged in the guiding groove.

5. The hinge assembly as claimed in claim 1, wherein the shaft comprises a shaft head and a shaft body extending from an end of the shaft head, the pinhole is defined in the shaft head and running therethrough.

6. The hinge assembly as claimed in claim 5, wherein a first end of the shaft body connects with the shaft head, an opposite second end of the shaft body defines a deformed shaft portion, and the socket defines a deformed hole, the deformed hole is engaged with the deformed shaft portion.

7. The hinge assembly as claimed in claim 6, wherein the hinge assembly further includes a clip, the deformed shaft portion defines a stub, and the clip is engaged with the stub and resists the socket.

8. The hinge assembly as claimed in claim 6, wherein the socket is a hollow cylinder in shape, a separating plate is defined at an inside wall of the socket, and the separating plate defines the deformed hole and a rib adjacent to the deformed hole.

9. The hinge assembly as claimed in claim 1, wherein the shift member defines a tab and the socket defines a pit, and the tab of the shift member is configured for engaging with the pit of the socket such that the shift member locks into the socket.

10. The hinge assembly as claimed in claim 1, wherein the hinge assembly further includes a button, the button is partially accommodated in the socket and resists the shift member.

11. The hinge assembly as claimed in claim 10, wherein the hinge assembly further includes a fixing member, the fixing member is secured in the socket such that the button is prevented from popping out of the socket.

12. A foldable electronic device, comprising:
a main body;
a cover; and
a hinge assembly pivotably connecting the main body and the cover, the hinge assembly comprising:
a shaft, wherein a pinhole is defined in the shaft;
a cam having a cam surface and a spiral slot, the cam rotatably sleeved on the shaft;
a pin disposed in the pinhole of the shaft and the spiral slot of the cam so that the cam being slidable and rotatable relative to the shaft;
a follower having a cam surface and an anti-rotating portion, the follower rotatably sleeved on the shaft, and the cam surface of the follower engaging with the cam surface of the cam;
a shift member having a controlling portion, the shift member being rotatably sleeved on the shaft, the controlling portion of the shift member slidable engaged with the anti-rotating portion of the follower so that the shift member being slidable and non-rotatable relative to the follower;
a first resilient element sleeved on the shaft, with a first end of the first resilient element resisting the follower and an opposite second end of the first resilient element resisting the shift member;
a socket secured on the shaft, the shift member locked into or unlocked from the socket; and
a second resilient element sleeved on the shaft, with a first end of the second resilient element resisting the follower to drive the cam surface of the follower to engage with the cam surface of the cam and an opposite second end of the second resilient element resisting the socket, wherein the cam is non-rotatably engaged with one of the cover and main body, the follower is non-rotatably engaged with another one of the cover and main body.

13. The foldable electronic device as claimed in claim 12, wherein the foldable electronic device further includes a sleeve, wherein the sleeve is sleeved on the shaft and between the follower and the shift member, the follower and the shift member are slidably engaged with the sleeve.

14. The foldable electronic device as claimed in claim 13, wherein the follower has a sliding groove and the sleeve has a sliding arm, and the sliding arm of the sleeve is slidably engaged in the sliding groove.

15. The foldable electronic device as claimed in claim 13, wherein the sleeve has a guiding groove and the shift member has a guiding arm, the guiding arm is slidably received in the guiding groove.

16. The foldable electronic device as claimed in claim 12, wherein the shaft comprises a shaft head and a shaft body extending from an end of the shaft head, the pinhole is defined in the shaft head and running therethrough.

17. The foldable electronic device as claimed in claim 16, wherein a first end of the shaft body connects with the shaft head, an opposite second end of the shaft body defines a deformed shaft portion, and the socket defines a deformed hole, the deformed hole is engaged with the deformed shaft portion.

18. The foldable electronic device as claimed in claim 17, wherein the foldable electronic device further includes a clip, the deformed shaft portion defines a stub, and the clip is engaged with the stub and resists the socket.

19. The foldable electronic device as claimed in claim 17, wherein the socket is a hollow cylinder in shape, a separating plate is defined at an inside wall of the socket, and the separating plate defines the deformed hole and a rib adjacent to the deformed hole.

20. The foldable electronic device as claimed in claim 12, wherein the shift member defines a tab and the socket defines a pit, and the tab of the shift member is configured for engaging with the pit of the socket such that the shift member locks into the socket.
